(19) United States
(12) Patent Application Publication
(10) Pub. No.: US 2016/0360697 A1
(43) Pub. Date: Dec. 15, 2016

(54) SYSTEM AND METHOD FOR AUTOMATICALLY CHANGING MACHINE CONTROL STATE

(71) Applicant: AGCO CORPORATION, Hesston, KS (US)

(72) Inventor: Diego F. Diaz, Wichita, KS (US)

(73) Assignee: AGCO CORPORATION, Hesston, KS (US)

(21) Appl. No.: 14/913,948

(22) PCT Filed: Sep. 3, 2014
(86) PCT No.: PCT/US2014/053808

§ 371 Date: Feb. 23, 2016

Related U.S. Application Data
(60) Provisional application No. 61/872,908, filed on Sep. 3, 2013.
(60) Provisional application No. 61/921,693, filed on Dec. 30, 2013.

(51) Int. Cl. A01D 41/127; B60W 10/20; B60W 50/08; G05D 1/00

(52) U.S. Cl. CPC A01D 41/1278; G05D 1/0061; B60W 10/20; B60W 50/08; G05D 2201/0201; B60W 2300/158; B60W 2540/04

(57) ABSTRACT

In one embodiment, a control system for a land machine, the control system comprising: a position indication component configured to generate position information that indicates a current geographic position of the machine; and a control unit configured to: receive the position information from the position indication component; and change a control state of the machine by either disabling, or enabling engagement of, an automatic steering function of the machine depending on the position information.

### CROSS REFERENCE TO RELATED APPLICATIONS

This application claims the benefit of U.S. Provisional Application Nos. 61/872,908 filed Sep. 3, 2013, and 61/921,693, filed Dec. 30, 2013, both of which are hereby incorporated by reference in their entirety.

### TECHNICAL FIELD

The present disclosure is generally related to managing a control state of mobile land machines.

### BACKGROUND

Some mobile land machines, such as mobile land machines used in the agriculture and construction industries, include systems for performing automatic guidance. Automatic guidance systems are equipped to determine a current location of the machine and to automatically steer the machine to follow a particular path, such as a predetermined path. Automatic guidance may be implemented by a control system onboard the machine that uses a global navigation satellite systems (GNSS) receiver and one or more actuators to drive movement of one or more steering components and/or drive systems. The control system may use position information received from the GNSS receiver to determine a current location of the machine and to plan and/or implement a travel path for the machine. As the machine travels the path, the control system uses continuously updated position information from the GNSS receiver to steer the machine in an automated manner to remain on and follow the path. Automatic steering may be used, for example, to precisely guide the machine along a desired path through a field or other unmarked areas as the machine works the field or area.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram that illustrates an example environment in which an embodiment of an example control system is implemented.

FIG. 2 is a screen diagram that illustrates an example user interface from an operator's perspective for an embodiment of an example control system that adjusts a machine state as an example mobile land machine transitions from a road to a field.

FIG. 3 is a screen diagram that illustrates an example user interface from an operator's perspective for an embodiment of an example control system that adjusts a machine state as an example mobile land machine transitions from a field to a road.

FIG. 4 is a screen diagram that illustrates an example user interface from an operator's perspective for an embodiment of an example control system that adjusts a machine state as an example mobile land machine advances proximally to a body of water in a worked field.

FIG. 5A is a block diagram that illustrates an embodiment of an example control system.

FIG. 5B is a block diagram that illustrates an embodiment of an example control unit implemented in an embodiment of the example control system of FIG. 5A.

FIG. 6 is a flow diagram that illustrates an embodiment of an example control method.

### DESCRIPTION OF EXAMPLE EMBODIMENTS

### Overview

In one embodiment, a control system for a land machine, the control system comprising: a position indication component configured to generate position information that indicates a current geographic position of the machine; and a control unit configured to: receive the position information from the position indication component; and change a control state of the machine by either disabling, or enabling engagement of, an automatic steering function of the machine depending on the position information.

### Detailed Description

Certain embodiments of a control system and associated method are disclosed that involve adjustment of a control state of a mobile land machine based at least on a detected geographic position of the machine. For instance, in the context of a machine equipped with an automatic guidance system that includes automatic steering functionality, the control system detects, in real-time, the geographic position of the machine, compares the detected position with locally-stored or network-accessed geographical information, and automatically activates or deactivates the guidance system. The guidance system comprises an automated steering function for the machine, which when the guidance system is active, is automatically enabled or disabled by the control system depending on the position of the machine. Also, when the guidance system is inactive (e.g., based on the machine geographical position), the automatic steering function cannot be engaged, avoiding inadvertent engagement. In some embodiments, the control system may adjust one or more functions (e.g., hydraulic, electrical, mechanical) of the machine (and/or associated implement) in association with the change in control state. Note that the terms activate, inactive, engage, and disengage, or the like, are used throughout the disclosure with distinction based on the context in which the terms are used. For instance, in one embodiment, when the control system activates a guidance system having automatic steering functionality, the control system makes the guidance system ready to work. Stated differently, for the automatic steering function to be engaged (or disengaged), the guidance system should be active. In one embodiment, when the control system makes the guidance system inactive (e.g., from an activated state), the automatic steering function cannot be engaged or disengaged when the guidance system is inactive. As to the terms engage and disengage, in one embodiment, to engage refers to the action(s) taken by the control system to use the guidance system to automatically steer the land machine, whereas disengage refers to the action(s) taken by the control system to stop automatic steering of the machine. In one embodiment, the guidance system is to be active in order for the automatic steering function to be engaged or disengaged by the control system. Accordingly, reference to the terms activation and deactivation generally refers to the guidance system, whereas reference to the terms engagement and disengagement generally refers to the automatic steering function of the guidance system.

Digressing briefly, a roading lockout or roading switch is a safety feature that disables automatic steering and all machine hydraulic functions when a conventional farming machine, such as a combine harvester, is driven on the road. Currently, this switch is located in the cab of the machine, such as in an armrest. An operator manually toggles (e.g., switches on or off) this switch to achieve activation or deactivation of the guidance system. However, manual activation or deactivation may create a safety hazard, such as if the operator forgets to toggle the switch while the machine is traveling on the road. Relying on manual activation and deactivation may also cause inconvenience if the switch is left active and the operator tries to engage automatic steering or hydraulic functions in the field. In contrast, certain embodiments of the disclosed control system eliminate or mitigate the need for manual entry by the machine operator by automatically activating or deactivating the automatic guidance system, and based on the state of the automatic guidance system, automatically engaging or disengaging the automatic steering functions and, in some embodiments, one or more hydraulic functions based on the current position of the machine.

Having summarized certain features of control systems of the present disclosure, reference will now be made in detail to the description of the disclosure as illustrated in the drawings. While the disclosure will be described in connection with these drawings, there is no intent to limit it to the embodiment or embodiments disclosed herein. For instance, in the description that follows, one focus is on an agricultural machine depicted in the figures as a self-propelled combine harvester, though it should be appreciated that some embodiments may use other agricultural machines (e.g., for tilling, planting, mowing, water or chemical disbursement, towing an implement, etc.) or mobile land machines from other industries, and hence are contemplated to be within the scope of the disclosure. Further, although the description identifies or describes specifics of one or more embodiments, such specifics are not necessarily part of every embodiment, nor are all various stated advantages necessarily associated with a single embodiment or all embodiments. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

Note that references hereinafter made to certain directions, such as, for example, “front”, “rear”, “left” and “right”, are made as viewed from the rear of the machine looking forwardly. Further, reference herein to land machine is intended to encompass mobile machines where all or at least a majority of intended travel by the machine is over land (as opposed to travel over or under water or through the air).

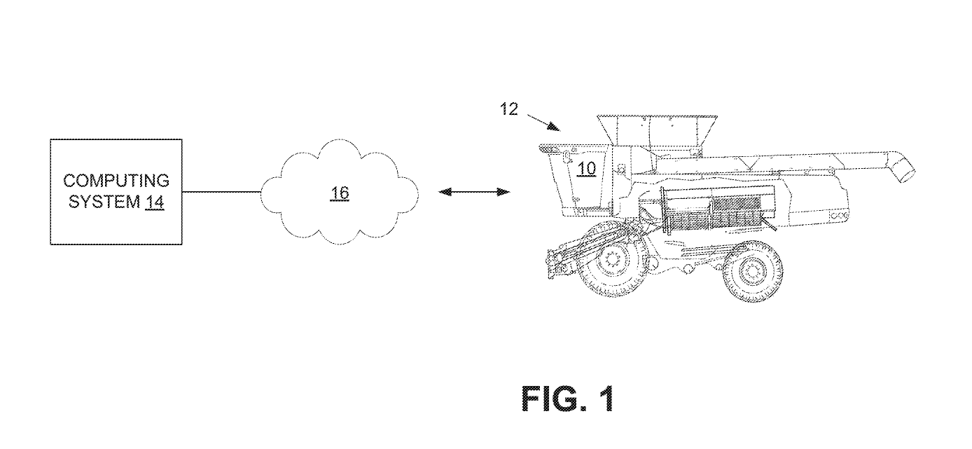

Referring now to FIG. 1, shown is an example environment in which an embodiment of a control system 10 may be used. In particular, the control system 10 is shown as functionality residing within a mobile land machine 12 (herein, simply referred to as a machine) depicted as a combine harvester for illustration. It should be appreciated within the context of the present disclosure that, though the machine 12 is primarily described, and always depicted, as a combine harvester, other machines used for the same or different operations may be used in some embodiments. Additionally, as described previously, mobile land machines for other industries may be used, and hence are contemplated to be within the scope of the disclosure. Further, it is noted that the machine 12 is shown in FIG. 1 without the attached implement (e.g., header of the combine) for purposes of brevity, with the understanding that one of a plurality of different types of headers may be used. The control system 10 is shown residing within the cab of the machine 12, but in some embodiments, one or more functionality of the control system 10, as explained further below, may be distributed throughout the machine 12, distributed among plural machines, and/or located remotely, such as in one or more computing systems, such as computing system 14. The computing system 14 may be embodied as one or more servers, or other computing device(s), that is located remotely from the machine 12 and is communicatively coupled to the control system 10 over a network 16. Note that the computing system 14 may include additional and/or other equipment (e.g., gateways, routers, switches, etc.), with functionality distributed among one or more facilities, such as an Internet Service Provider (ISP) facility, regional or local machine manufacturer's representative facility, manufacturer's facility, residence, among other facilities. In some embodiments, the computing system 14 may store and update one or more data structures (e.g., databases) of geographical information (e.g., maps, including field boundary coordinates, topographic information, etc.) for fields farmed using the machine 12 or other machines. Other data may be stored, such as the manufacturer of the machine 12 or other machines used on the field, the product dispensed (e.g., historically) on the field (e.g., in the case of planting or spraying applications), among other useful data.

The network 16 may include one or more networks based on one or a plurality of communication protocols. For instance, the network 16 may comprise a wide area network, such as the Internet, one or more local area networks, such as a radio frequency (RF) network, a cellular network, POTS, WiFi, WiMax, and/or other networks, such as a satellite or other terrestrial networks. In one embodiment, the computing system 14 may host a web-service, or serve as a gateway to one or more other servers in the Internet (e.g., as a gateway to a cloud service), and be coupled to the control system 10 over a wireless, cellular connection. The control system 10, as indicated above, is coupled to a satellite network to enable a determination by the control system 10 of the current position (e.g., geographic position) of the combine 12, enabling guided farming operations including automatic steering and generally, navigation control via an automatic guidance system.

The machine 12, as should be appreciated by one having ordinary skill in the art, comprises various systems to enable machine functionality. For instance, the machine 12 comprises an automatic guidance system that includes automatic steering functionality, a feeder house assembly that enables coupling to one of a plurality of different types of headers and that raises and lowers the header during various stages of operation, among others. These and other known systems of the machine 12 may be activated and/or controlled using hydraulics. In addition, one or more of these and/or other machine functionality may use additional and/or other mechanisms for the generation, transmission, and/or control of power, such as via electrical, pneumatic, and/or mechanical mechanisms, as should be appreciated by one having ordinary skill in the art.

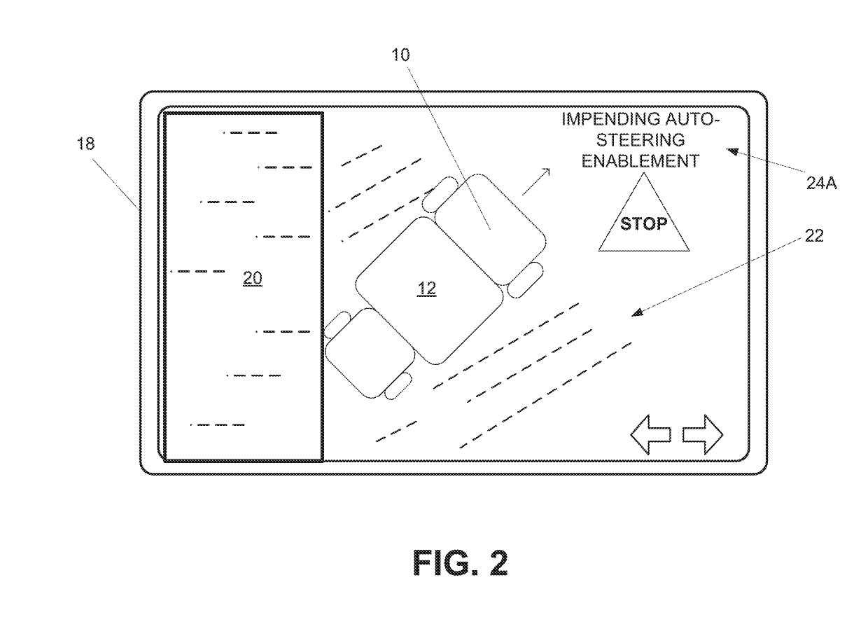

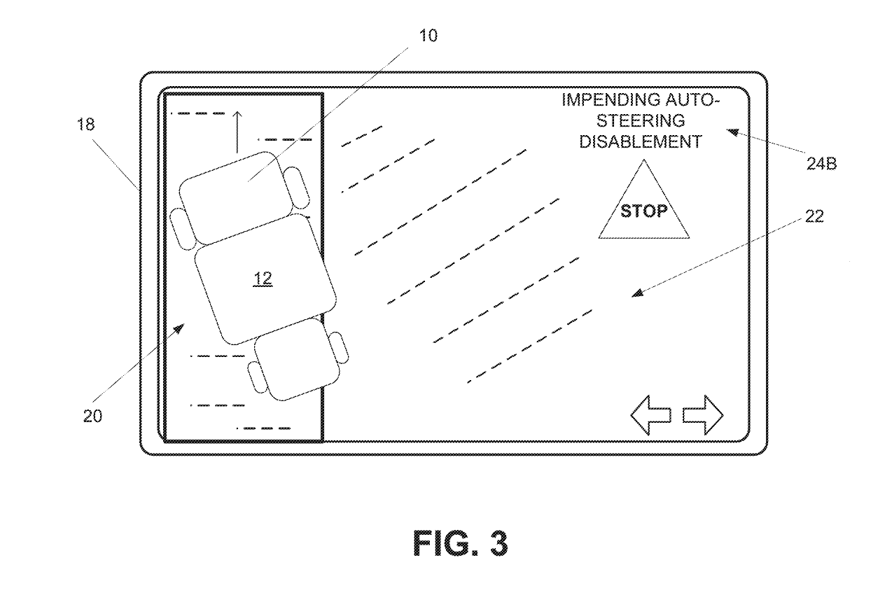

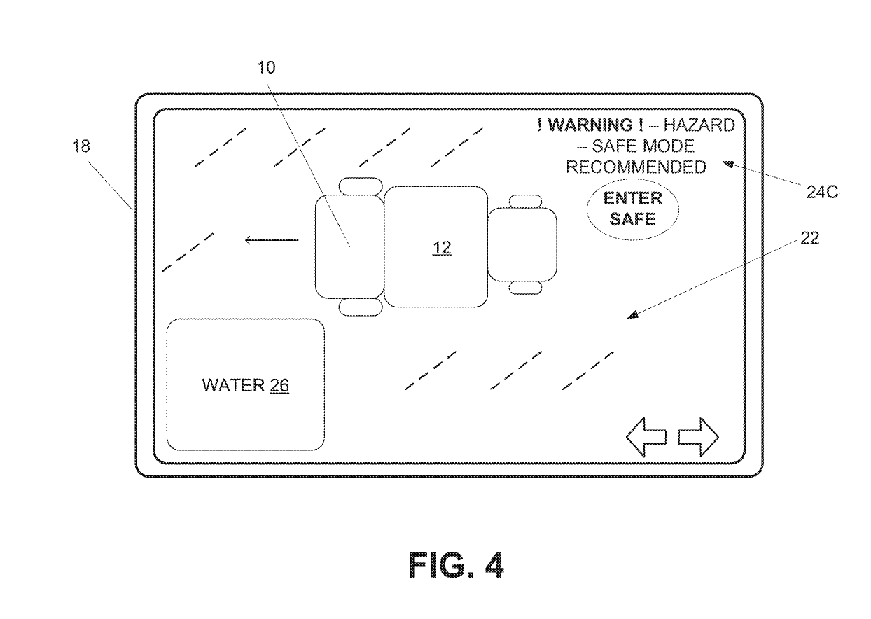

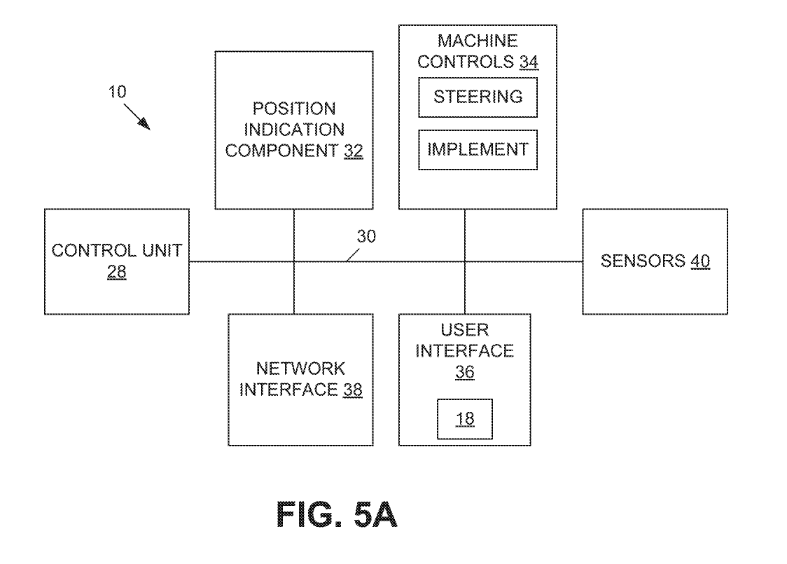

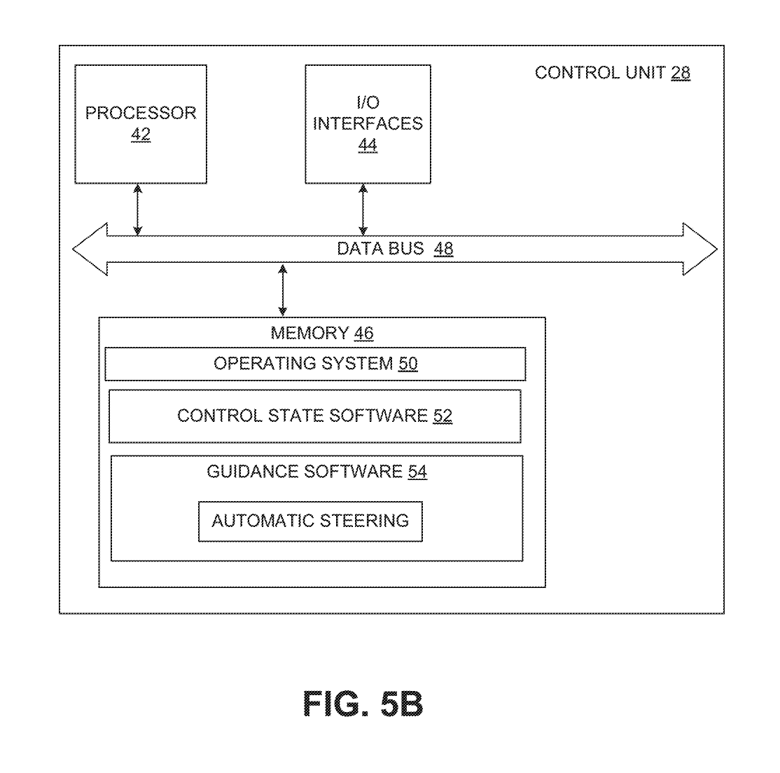

The control system 10 changes a control state of the machine 12 based on the detected geographical position of the machine 12. In one embodiment, the control state is changed via the activation or deactivation of the guidance system. In some embodiments, the control state is changed via the activation/deactivation of the guidance system and the change in operating state (e.g., engagement) of the automatic steering function (and in some embodiments, one or more hydraulic functions). As suggested above, the control system 10 may also adjust one or more hydraulic functions (and/or systems powered by other mechanisms) in association with the change in the control state of the combine 12. For instance, attention is directed to FIGS. 2-4, with each figure illustrating an example user interface 18 (e.g., display screen, such as plasma-based or cathode ray tube, among others) that depicts in overhead plan view a graphic (or in some embodiments, real-time image) of the machine 12, though in some embodiments, additional and/or other viewing-perspectives may be presented to an operator. The plan view (among other views if used) may be as viewed in real-time by an operator of the machine 12 as the machine 12 transitions from a road to a field (FIG. 2), from a field to a road (FIG. 3), and as the machine 12 travels proximal to a body of water (FIG. 4). The user interface 18 may present a map (e.g., satellite or graphical view) with areas of one or more roads and/or fields within a defined range of the current machine location, where in some embodiments, the range presented varies depending on the view desired and selected by the operator. The user interface 18 is coupled to a control unit (shown in FIGS. 5A-5B) of the control system 10, and is used to present to an operator real-time feedback of combine navigation as well as (in some embodiments) an indication of changes or recommended changes in control state of the machine 12. For instance, in one embodiment, the indication may comprise a message (and/or representative symbol in some embodiments) of a recommended control state change that requires an operator to respond (e.g., via touch-screen, or manipulation of a cursor, verbally, or via manipulation of other controls, among other known mechanisms) before commencement of the control state change. In some embodiments, the indication may merely provide a warning of an impending change in a control state that is implemented without operator intervention, though the operator may interrupt the implementation, or the indication may provide feedback of the change (e.g., post-implementation) in some embodiments. In some embodiments, the indication may not be presented, or be presented in an additional and/or different way (e.g., via aural feedback, or in accordance with another type of user interface). Similarly, in some embodiments, operator feedback of machine navigation may not be presented, or may be presented in accordance with another and/or additional user interfaces.

Continuing with reference to FIG. 2, presented on the user interface 18 is a graphic (or in some embodiments, a real-time image) of the machine 12 as it transitions from a road 20 to a field 22. In some embodiments, the machine 12 may be represented according to a different graphic symbol. In other words, it should be appreciated within the context of the present disclosure that other views than those shown in FIGS. 2-4 may be presented in some embodiments, and hence are contemplated to be within the scope of the disclosure. An operator may navigate the machine 12 along the road 20 to the desired entrance to the field 22 and steer the machine 12 onto the field 22. The control unit of the control system 10 receives position information from a position detection component of, or in some embodiments, associated with, the control system 10, and compare the geographical position of the machine 12 with geographic information (e.g., a map of the field and/or road, such as geographic coordinates corresponding to the entire field or field boundaries or recorded entrance coordinates (e.g., from prior traversal)) to identify the machine position. In the depicted example, the control unit determines that the machine 12 is on the field 22, and transitions the control state of the machine 12 from a road state to a field state, as further described below.

At a time corresponding to the determination to change the control state, the control unit may cause an indication 24A to be presented on the user interface 18. The indication 24A may be presented immediately before the actual change in control state, during, and/or after the change in control state. The indication 24A may take on one of a variety of different formats, such as in the form of a textual message with or without a banner, a pop-up window, a symbol or symbols, among other known-graphical user interface (GUI) formats. In some embodiments, the indication 24A may include an icon that enables direct selection (e.g., touch screen, via cursor, etc.) or indirect selection via selected user interface controls suggested by the icon (similar to function keys and function key symbols), the direct or indirect selection enabling the operator to affirm, confirm, or interrupt (e.g., deny or delay) the change in control state. In the depicted example, the indication 24A is a transitory message (e.g., that disappears on its own, or in some embodiments, after operator intervention) on the screen warning the operator of the impending change in state, with a selectable icon giving the operator an opportunity to interrupt (e.g., “stop”) the change to the field state.

In the field state, the control unit of the control system 10 enables engagement or disengagement of an automatic steering function of the guidance system of the machine 12. For instance, enabling engagement may involve activating the automatic guidance system of the machine 12 via signaling by software in the control unit, which may trigger engagement by the guidance software of the automatic steering function. The guidance software is used to control the automatic steering function. Associated with the enablement of the engagement (or disengagement) of the automatic steering function, in some embodiments, is the engagement (or disengagement) of one or more hydraulic functions of the machine 12. In effect, the automatic guidance system is activated by the control unit, which permits engagement of the automatic steering function. As a somewhat similar analogy, a loaded gun (the steering function) is unable to be operated (fired or engaged) until the safety (guidance software) is deactivated (safety removed), the latter function differing in this example analogy since the safety is removed to fire versus triggering by the guidance system of the automatic steering function to operate. Once the engagement of the automatic steering function is enabled (via activation of the guidance system), the automatic steering function may be started either via operator input or automatically (without operator intervention) by the guidance system. In some embodiments, one or more machine parameters (e.g., travel speed, heading, and/or operating state of an implement, such as header operations) may be used in the activation of the guidance system (or in some embodiments, in the engagement of the automatic steering function). For instance, the guidance system may not be activated (and hence, in one embodiment, the automatic steering function may not be engaged), until a combination of two or more events or conditions occur. For instance, the control unit of the control system 10 may receive machine parameters such as speed and/or heading, and use the position of the machine 12 relative to the entrance to the field, as well as the speed and heading to anticipate or predict that the machine 12 will enter the field within a predetermined amount of time, enabling the change in control state before the machine 12 actually enters onto the field 22. In some embodiments, the automatic guidance system may be activated, yet the automatic steering function may not be triggered by the guidance system (with or without operator intervention) until the combination of two or more events have occurred.

Referring to FIG. 3, the machine 12 is depicted as transitioning from the field 22 to the road 20. Similar to the mechanisms described above for the road-to-field transition, the control unit of the control system 10 receives position information from a position detection component of, or in some embodiments, associated with, the control system 10, and compares the geographical position of the machine 12 with geographic information (e.g., a map of the field and/or road, including geographic coordinates corresponding to all of the field or field boundaries or recorded entrance coordinates (e.g., from prior traversal)) to identify the machine position. If the control unit determines that the machine 12 is on the road 20 (or is travelling with a heading and/or speed that will place the machine on the road within a predetermined amount of time or distance), the control unit may change the operating state of the machine 12 to a road state. At a time corresponding to the determination to change the control state, the control unit may cause an indication 24B to be presented on the user interface 18. The indication 24B may be presented immediately before the actual change in control state, during, and/or after the change in control state. The indication 24B may take on a similar form as explained above for the indication 24A. In the depicted example, the indication 24B is a transitory message on the screen warning the operator of the impending change in state. Similar to the description above for the indication 24A, the indication 24B may also provide the operator with the option (e.g., a “stop” icon) of not allowing the control system 10 to enter the road state, which may be important if the machine is on the road to actually work the road rather than as a route to transition to another field location.

The road state of the machine 12 may include, for example, disabling automatic steering, disabling or limiting hydraulic functions (such as hydraulic functions used to operate an implement), and/or limiting steering (e.g., range and/or speed, which may include limiting hydraulic functions in some embodiments) to prevent sharp turns at higher speeds. For instance, software of the control unit of the control system 10 may deactivate the guidance software and provide control signals to one or more hydraulic actuators. Note that the function of limiting steering may be particularly useful, for example, with machines that include rear-wheel or all-wheel steering. For machines with an adjustable-height chassis or adjustable-height components, the road state may include adjusting the height of the chassis or components to a designated travel height. A tall machine, for example, may need to be lowered for safe road travel, or a machine with an adjustable component that is normally close to the ground during normal operations may need to be raised to avoid damage to the adjustable component during road or high-speed travel. The control unit may compare a stored predefined value for various machine parameters with current detected values to assist in the determination of changing the control state of the machine 12.

In addition to detecting that the machine 12 is on the road 20, for example, the control unit may receive and process one or more (e.g., in combination) machine parameters in determining whether to change the control state of the machine 12. Some example machine parameters include the speed of the machine 12 and the operating state of an implement associated with the machine 12, though additional and/or other machine parameters may be used, such as pitch, heading, etc. For instance, the control unit of the control system 10 may detect that the machine 12 is on the road 20, but not switch control states until the machine 12 has reached a predetermined speed, such as 20 kilometers per hour, 25 kilometers per hour or 30 kilometers per hour. Similarly, a control unit may not switch control states if an implement is functioning, such as when a tractor is mowing along a roadway.

As is evident from the above examples, automatically switching the control state of the machine 12 eliminates or mitigates the risk of the operator inadvertently leaving the machine 12 in a dangerous control state when travelling on a road, and simplifies operation of the machine 12. In addition to avoiding dangerous or undesirable control conditions when travelling on the road, the control state may be automatically changed to address risks or needs in other situations as well. For instance, and referring to FIG. 4, the control unit of the control system 10 may detect that the machine 12 is operating proximate to a body of water 26, such as a lake or river, and automatically enter a safe control mode, wherein the control unit automatically disables automated steering or suggests that automated steering be disabled, as shown by the indication 24C presented on the user interface 18 with a selectable “enter safe” icon. It should be appreciated within the context of the present disclosure that other and/or additional information may be presented on the user interface 18 in some embodiments. Although a body of water is chosen as one example type of topographic feature that prompts the control unit to implement or suggest a control state change, the detection of other types of topographic features may likewise prompt automatic entry (or suggested entry) to a safe mode, such as when the machine 12 is proximal to a cliff or other potentially hazardous topographic feature of the field (or in some embodiments, other detected obstacles, such as an animal detected by the machine 12, or an environmentally sensitive area of the field 22).

With continued reference to FIG. 1, attention is now directed to FIG. 5A, which illustrates an embodiment of a control system 10. It should be appreciated within the context of the present disclosure that some embodiments may include additional components or fewer or different components, and that the example depicted in FIG. 5A is merely illustrative of one embodiment among others. Further, in some embodiments, the control system 10 may be distributed among plural machines. For instance, functionality of the control system 10 may be distributed among a towing machine and a towed machine, such as to enable the change in control state of both the towing and towed machines. The control system 10 comprises one or more control units, such as the control unit 28. The control unit 28 is coupled via one or more networks, such as network 30 (e.g., a CAN network or other network, such as a network in conformance to the ISO 11783 standard, also referred to as “Isobus”), to a position indication component 32 (e.g., which may include one or more receivers that include the ability to access one or more constellations jointly or separately via a global navigation satellite system (GNSS), such as global positioning systems (GPS), GLONASS, Galileo, among other constellations, including terrestrial components that permit positioning, such as via triangulation and/or other known methods), machine controls 34, a user interface 36 (which in one embodiment includes the user interface 18), a network interface 38, and one or more sensors 40. Note that control system operations are primarily disclosed herein in the context of control via a single control unit 28, with the understanding that additional control units 28 may be involved in one or more of the disclosed functionality.

In one embodiment, the position indication component 32 comprises a GNSS receiver that continually updates the control unit 28 with real-time position information that indicates a current geographical position of the machine 12. The position indication component 32 may enable autonomous or semi-autonomous operation of the machine 12 in cooperation with the machine controls 34 and the control unit 28 (e.g., via guidance software residing in, or accessed by, the control unit 28).

The machine controls 34 collectively comprise the various actuators (e.g., hydraulic actuators, though not limited to hydraulic mechanisms) and/or subsystems residing on the machine 12, including those used to control machine navigation (e.g., speed, direction (such as the steering system), etc.), implement operations (e.g., header or trailer position, on/off or operational state, etc.), chassis control, among other internal processes. In one embodiment, as depicted in FIG. 5A, the machine controls 34 comprise the steering system and implement system, each comprising one or more associated actuator devices. For instance, the actuator(s) of the steering system receive control signals from the control unit 28 and responsively drive one or more known steering components of the steering system. For guided steering, the control unit 28 may receive and process position information and geographic information, among possibly other information such as machine parameters, and process the information and responsively send the control signal(s) to the one or more actuators of the steering system. Note that in some embodiments, the enabling and disabling of the automatic steering function (and/or the activation and deactivation of the guidance system in some embodiments) may be achieved all or in part by the computing system 14 (FIG. 1).

Note that the machine controls 34 are described above in the context of the machine 12 as depicted in FIG. 1, but as previously indicated, other types of land machines are contemplated to be within the scope of the disclosure. Accordingly, other machine controls 34 that may be adjusted in association with changes in machine control state or for which operational state may be monitored may involve adjustments in chassis height, mower operations, and/or monitoring of chemical and/or water dispensing yield, efficiency and/or flow, among others.

The user interface 36 may include one or more of a keyboard, mouse, microphone, touch-type display device, joystick, steering wheel, or other devices (e.g., switches, immersive head set, etc.) that enable input and/or output by an operator (e.g., to respond to indications presented on the screen or aurally presented) and/or enable monitoring of machine operations. As noted above, the user interface 18 may be a component of the user interface 36.

The network interface 38 comprises hardware and/or software that enable wireless connection to the network 16 (FIG. 1). For instance, the network interface 38 may cooperate with browser software or other software of the control unit 28 to communicate with the computing system 14 (FIG. 1), such as via cellular links, among other telephony communication mechanisms and radio frequency communications. In some embodiments, the computing system 14 may host a cloud service, whereby all or a portion of the functionality of the control unit 28 resides on the computing system 14 and is accessed by the control unit 28 via the network interface 38. For instance, the computing system 14 may receive position information from the control unit 28 (via the network interface 38) and based on geographic information stored at, or in association with, the computing system 14, determine whether the machine 12 is located on the road or the field and communicate that determination to the control unit 28 wirelessly over the cloud (e.g., network 16) for subsequent action to change the control state. In some embodiments, the computing system 14 may actually control (e.g., effect) the change in control state, such as in autonomous farming operations. The network interface 38 may comprise MAC and PHY components (e.g., radio circuitry, including transceivers, antennas, etc.), as should be appreciated by one having ordinary skill in the art.

The sensors 40 may comprise the various sensors of the machine 12 to sense machine parameters, such as travel speed, heading (direction), pitch, temperature, operational state (e.g., detecting whether an implement is engaged and in operation, detecting threshing efficiency, such as via acoustic sensors located at the shoe, etc.). The sensors 40 may be embodied as contact (e.g., electromechanical sensors, such as position sensors, safety switches, etc.) and non-contact type sensors (e.g., photo-electric, inductive, capacitive, ultrasonic, etc.), all of which comprise known technology.

In one embodiment, the control unit 28 is configured to receive and process information from the network interface 38, the position indication component 32, the sensors 40, the machine controls 34, and/or the user interface 36. For instance, the control unit 28 may receive input from the user interface (e.g., display screen) 18, such as to enable intervention of machine operation by the operator (e.g., to acknowledge changes in control state or to permit or deny changes in control state), as well as to enter various parameters or constraints. As an example of the latter, a start-up session hosted by the control unit 28 (or a configuration session that can be prompted at other times) may enable the operator to set a threshold amount of time or distance of travel before the combine 12 is permitted to automatically change control state based on a determination of the combine location relative to a road, field, or certain field topographies and/or other obstacles. In some embodiments, the control unit 28 may receive input from the machine controls 34 or associated sensors (e.g., such as to enable feedback as to the position or status of certain devices, such as a header height and/or width, and/or speed, direction of the machine 12, etc.). The control unit 28 is also configured to cause the transmission of information (and/or enable the reception of information) via the network interface 38 for communication with the computing system 14, as set forth above.

FIG. 5B further illustrates an example embodiment of the control unit 28. One having ordinary skill in the art should appreciate in the context of the present disclosure that the example control unit 28 is merely illustrative, and that some embodiments of control units may comprise fewer or additional components, and/or some of the functionality associated with the various components depicted in FIG. 5B may be combined, or further distributed among additional modules, in some embodiments. It should be appreciated that, though described in the context of residing in the machine 12, in some embodiments, the control unit 28, or all or a portion of its corresponding functionality, may be implemented in a computing device or system (e.g., computing system 14) located external to the machine 12. Referring to FIG. 5B, with continued reference to FIG. 5A, the control unit 28 is depicted in this example as a computer system, but may be embodied as a programmable logic controller (PLC), field programmable gate array (FPGA), application specific integrated circuit (ASIC), among other devices. It should be appreciated that certain well-known components of computer systems are omitted here to avoid obfuscating relevant features of the control unit 28. In one embodiment, the control unit 28 comprises one or more processors (also referred to herein as processor units or processing units), such as processor 42, input/output (I/O) interface(s) 44, and memory 46, all coupled to one or more data busses, such as data bus 48. The memory 46 may include any one or a combination of volatile memory elements (e.g., random-access memory RAM, such as DRAM, and SRAM, etc.) and nonvolatile memory elements (e.g., ROM, hard drive, tape, CDROM, etc.). The memory 46 may store a native operating system, one or more native applications, emulation systems, or emulated applications for any of a variety of operating systems and/or emulated hardware platforms, emulated operating systems, etc.

In some embodiments, the memory 46 may store geographical information, such as one or more field maps (e.g., geographical coordinates of the entire field or field boundaries) and geographical coordinates of roads that access the fields. The geographical information may include topographic feature of the fields or roads in some embodiments. The field maps may be in the form of aerial imagery or recorded geographical coordinates of one or more fields, including recorded entry points, identified boundaries of the one or more fields, paths or waylines as previously determined, customizations, and/or other data pertinent to auto-farming implementations. In some embodiments, the geographical information may be stored remotely (e.g., at the computing system 14), or stored in distributed manner (e.g., in memory 46 and remotely). In the embodiment depicted in FIG. 5B, the memory 46 comprises an operating system 50, control state software 52, and guidance software 54. It should be appreciated that in some embodiments, additional or fewer software modules (e.g., combined functionality) may be deployed in the memory 46 or additional memory. In some embodiments, a separate storage device may be coupled to the data bus 48, such as a persistent memory (e.g., optical, magnetic, and/or semiconductor memory and associated drives).

The control state software 52 receives position information (e.g., from the position indication component 32) and compares the position information with geographic information stored locally or remotely and determines the position of the machine relative to a road, field, and/or topographic feature. Based on the determined position, the control state software 52, as executed by the processor 42, provides one or more control signals to the guidance software 54 and/or machine controls 34 to change the control state for one or more functionality of the machine (e.g., automatic steering). For instance, the change in control state may involve the control state software 52 signaling to the guidance software 54 to activate the guidance software 54, which enables the engagement (or disengagement, such as when the guidance software 54 is signaled to shut-down) of the automatic steering function. In some embodiments, the change in control state may be associated with adjusting one or more hydraulic systems, such as to limit, enable, or disable the hydraulic functions, and/or adjust an operating state of an implement operatively coupled to the machine 12. As noted above, the control state software 52 may change the control state after a pattern or series of events or conditions (or in some embodiments, the automatic steering function may not be triggered by the guidance software 54 until after the occurrence of these events), such as when the machine 12 is detected to be on the road and a machine parameter is received that reveals that the speed of the machine 12 has reached or exceeded a predefined value. As another example, the control state software 52 may change the control state after it is determined that the machine 12 is proximal to the road and heading toward the road (e.g., and further, at a given detected acceleration rate or speed). Another condition in the pattern or series of events may be operator intervention via the user interface 36.

In one embodiment, the guidance software 54 is activated or deactivated by the control state software 52. When activated, the guidance software 54 may coordinate inputs from the position indication component 32 and output control signals to one or more machine controls 34 to enable guided traversal on a field. In some embodiments, the functionality (e.g., executable code) of the control state software 52 may be embodied in the guidance software 54, and in some embodiments, the functionality (e.g., executable code) of the guidance software 54 may be embodied in the control state software 52.

Execution of the software modules 50-54 may be implemented by the processor 42 under the management and/or control of the operating system 50. In some embodiments, the operating system 50 may be omitted and a more rudimentary manner of control implemented. The processor 42 may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the control unit 28.

The I/O interfaces 44 provide one or more interfaces to the network 30 and other networks. In other words, the I/O interfaces 44 may comprise any number of interfaces for the input and output of signals (e.g., analog or digital data) for conveyance of information (e.g., data) over the network 30. The input may comprise input by an operator (local or remote) through the user interface 36 and input from signals carrying information from one or more of the components of the control system 10, such as the position indication component 32, machine controls 34, sensors 40, and/or the network interface 38, among other devices.

When certain embodiments of the control unit 28 are implemented at least in part with software (including firmware), as depicted in FIG. 5B, it should be noted that the software can be stored on a variety of non-transitory computer-readable medium for use by, or in connection with, a variety of computer-related systems or methods. In the context of this document, a computer-readable medium may comprise an electronic, magnetic, optical, or other physical device or apparatus that may contain or store a computer program (e.g., executable code or instructions) for use by or in connection with a computer-related system or method. The software may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

When certain embodiment of the control unit 28 are implemented at least in part with hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

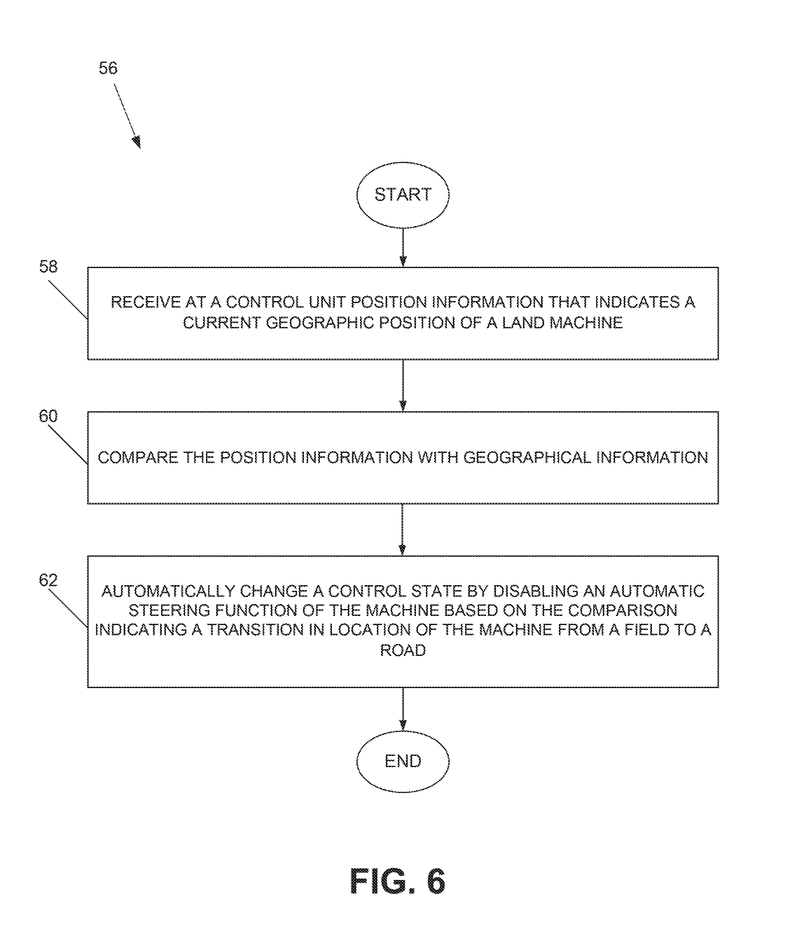

In view of the above description, it should be appreciated that one embodiment of a control method 56, depicted in FIG. 6, comprises receiving at one or more control units position information that indicates a current geographic position of a land machine (58); comparing the position information with geographical information (60); and automatically changing a control state by disabling an automatic steering function of the machine based on the comparison indicating a transition in location of the machine from a field to a road (62). As noted above, in some embodiments, the disablement may be achieved by the control state software 52 signaling to the guidance software 54 to deactivate, which triggers the disengagement of the automatic steering function. In some embodiments, the disablement may be achieved via signaling from the control state software 52 directly to the automatic steering function, or in some embodiments, the signaling by the guidance software 54 to the steering function without control state software intervention. In some embodiments, disablement may be achieved by a combination of signaling the guidance and/or automatic steering function software and one or more hydraulic actuators associated with the automatic steering function.

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein. Although the control systems and methods have been described with reference to the example embodiments illustrated in the attached drawing figures, it is noted that equivalents may be employed and substitutions made herein without departing from the scope of the disclosure as protected by the following claims.

At least the following is claimed:

1. A control system for a land machine, the control system comprising:
a position indication component configured to generate position information that indicates a current geographic position of the machine; and
a control unit configured to:
receive the position information from the position indication component; and
change a control state of the machine by either disabling, or enabling engagement of, an automatic steering function of the machine depending on the position information.

2. The control system of claim 1, wherein the control unit is further configured to limit a steering range or a steering speed when the automatic steering function is disabled.

3. The control system of claim 1, wherein in association with the change in the control state, the control unit adjusts one or more hydraulic functions of the machine.

4. The control system of claim 3, wherein the control unit adjusts by limiting the one or more hydraulic functions of the machine.

5. The control system of claim 3, wherein the control unit adjusts by disabling the one or more hydraulic functions of the machine.

6. The control system of claim 3, wherein the control unit adjusts by enabling the one or more hydraulic functions of the machine.

7. The control system of claim 1, wherein the control unit is further configured to:
receive a machine parameter;
compare the machine parameter with a predefined value for the machine parameter; and
use a result of the comparison to determine whether to change the control state.

8. The control system of claim 7, wherein the machine parameter comprises travel speed.

9. The control system of claim 7, wherein the machine parameter comprises an operating state of an implement operatively coupled to the machine.

10. The control system of claim 1, wherein the control unit is further configured to change an operating state of a second machine towed by the machine, the change in the operating state occurring at a time corresponding to the change in the control state of the machine.

11. The control system of claim 1, wherein the control unit is configured to change the control state based on geographical information, the geographical information comprising geographical coordinates corresponding to one or more fields and one or more roads that enable access to the one or more fields, the roads and fields collectively within a defined range of the position information.

12. The control system of claim 11, wherein the geographical information comprises topographic features of the one or more fields or an obstacle located on or proximally to the one or more fields.

13. The control system of claim 12, wherein the control unit is further configured to transition the machine to a safe mode or recommend to an operator via a user interface to take an action to cause the transition responsive to the machine traveling proximally to a first type of topographic feature.

14. The control system of claim 11, further comprising a communications device coupled to the control unit, wherein the control unit is configured to access the geographical information based on receiving the geographical information from a remote server through the communications device.

15. The control system of claim 1, further comprising a user interface, wherein the control unit is configured to provide an indication to an operator, though the user interface, of the change in the control state or an impending change in the control state.

16. The control system of claim 15, wherein the control unit is configured to change the control state with operator intervention enabled through the user interface.

17. A system, comprising:
a land machine, comprising:
an automated steering system; and
a position indication component configured to generate position information that indicates a current geographic position of the machine; and
a control unit configured to:
compare the position information with geographical information; and
change a control state of the machine by either disabling, or enabling engagement of, the automated steering system depending on a result of the comparison.

18. The system of claim 17, wherein the control unit is further configured to adjust one or more machine parameters in association with the change in the control state.

19. The system of claim 17, wherein the control unit is further configured to receive one or more machine parameters, wherein the control unit is further configured to change the control state based on a combination of the result and the one or more machine parameters, wherein the control unit is configured to:
disable the automated steering system when the result indicates that the machine is on a road or in a process of transitioning to the road, or
enable the engagement of the automated steering system when the result indicates that the machine is on a field or in a process of transitioning to the field.

20. A method, comprising:
receiving at a control unit position information that indicates a current geographic position of a land machine;
comparing the position information with geographical information; and
automatically changing a control state by disabling an automatic steering function of the machine based on the comparison indicating a transition in location of the machine from a field to a road.
